(19) United States
(12) Patent Application Publication
(10) Pub. No.: US 2009/0143178 A1
(43) Pub. Date: Jun. 4, 2009

(54) SHOCK ABSORBING STRUCTURE IN IDLER

(76) Inventors: Shunji Sakura, Osaka (JP); Akira Hirai, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/269,933

(22) Filed: Nov. 13, 2008

(30) Foreign Application Priority Data
Nov. 29, 2007 (JP) 2007-308794

(51) Int. Cl. F16H 55/30

(52) U.S. Cl. 474/152

(57) ABSTRACT

A shock absorbing structure in an idler in which the shock of first abutment of a roller in a roller chain in a case where the roller engages with an idler sprocket, is absorbed or reduced The structure has an idler 1 and a supporting shaft 2 fixed to a fixed body 9. The shaft has one oil supply hole 2c extending in a substantially radial direction from a central reservoir 10 to the outer circumference of the shaft. The supporting shaft 2 is positioned such that the oil supply hole 2c extends toward a position where a roller 5 first abuts when the roller 5 engages with a standard tooth form idler sprocket 3. The idler sprocket 3 is provided with a plurality of oil injection holes extending in a substantially radial direction, each of which terminates in an outlet in one of the tooth gaps 3a of the sprocket 2. The oil injection holes 3b sequentially register with the oil supply hole 2c, to inject oil into he tooth gaps. The oil is supplied by an oil pump 11 through the central reservoir 10.

### FIELD OF INVENTION

The present invention relates to a shock absorbing structure in an idler used in a power transmission mechanism or a transfer machine or the like of an automobile, an industrial machine and the like.

### BACKGROUND OF THE INVENTION

As to roller chains and sprockets used in a roller chain power transmission mechanism, the Japanese Industrial Standard (JIS) has been established (see JIS B1801-1997 (transmitting roller chain and bush chain)).

The sprockets and their tooth forms defined in this JIS are called as standard sprockets and standard tooth forms, respectively.

Further, as an element, which reduces impact noises of a chain roller, a low noise sprocket has been provided in which an axially penetrating absorber retaining groove with a narrow opening is provided in the vicinity of a tooth gap surface of an engagement tooth of a chain roller and an elastic absorber protruding from said tooth gap surface is press-fitted to the retaining groove (see for example Japanese Laid-Open Patent Publication No. Hei. 9-119508)

### PROBLEMS TO BE SOLVED BY THE INVENTION

However, when standard sprockets defined in the above-mentioned JIS B1801-1997 are used in a roller chain transmission mechanism, a member, which functions as an absorbing member, does not exists at the time of engagement between a roller of the roller chain and a standard sprocket tooth. Thus, collision energy between the roller of the roller chain and the standard sprocket tooth is increased, which resulted in causes of noises and vibrations.

Since a low noise sprocket disclosed in the above-mentioned Japanese Laid-Open Patent Publication No. Hei. 9-119508 uses an elastic absorber composed of hydrogenated nitrile butadiene rubber, fluororubber or urethane rubber and the like as means for reducing impact noises of a chain roller, there is a problem that the wear or worn-out condition of the elastic shock absorber is generated whereby the performance cannot be maintained for a long period of time.

Accordingly, the object of the present invention is to provide a shock absorbing structure in an idler in which the shock of first abutment of a roller in a roller chain in a case where the roller engages with an idler sprocket is absorbed or reduced and the absorbing function can be maintained for a long period of time.

### SUMMARY OF THE INVENTION

The invention is a shock absorbing structure in an idler comprising a supporting shaft fixed to a fixed body, an idler sprocket having a bore rotatably supported on said supporting shaft and a roller chain having rollers which engage with said idler sprocket. The sprocket has a series of peripheral teeth separated by a series of tooth gaps. The chain, in turn, has a series of rollers which are adapted to engage into the series of tooth gaps when the chain travels from a free run into a path around the sprocket. The chain's travel in engagement with sprocket causing the sprocket to rotate. The supporting shaft is provided with one oil supply hole in a substantially radial direction, which is directed toward the position where the said roller first engages with said idler sprocket. The idler sprocket is provided with a plurality of oil injection holes, each hole extending in a substantially radial direction from the bore to an outlet opening in the bottom of a tooth gap of the idler sprocket. The oil injection holes are adapted to sequentially register with the oil supply hole, and the oil supply hole communicates with an oil supply source through an oil reservoir to supply oil to the tooth gap.

The outlets of the invention may have their centers either at position at the center of the tooth gap, or at a position shifted from the center of said each tooth gap.

In a shock absorbing structure according to the invention, the following effects are obtained.

Since the idler sprocket has oil injection holes in a substantially radial direction whose outlets are opened at the respective tooth gaps, the shock applied by pressure of oil injected from outlets of the oil injection holes to the respective tooth gaps when a roller of the roller chain first abuts on each tooth gap of the idler sprocket, can be absorbed.

Since oil is injected from an outlet of the oil injection holes to a tooth gap of the idler sprocket only when the outlet of the oil supply hole is aligned with an inlet of the oil injection holes, the consumption of oil can be decreased.

Since the oil injected to the tooth gap of the idler sprocket has a function of lubricating oil, wear of parts can be prevented.

Further, the oil injected to the tooth gap of the idler sprocket has a cooling effect, which cools the idler sprocket and the roller chain.

Since in a related art an elastic shock absorber liable to generate wear or worn-out condition is used, continuation of the shock absorbing effect for a long period of time is impossible. However, according to the invention according to claim 1, since the shock applied by pressure of injected oil when the roller first abuts, is absorbed, its function can be maintained for a long period of time.

Further, according to the invention according to claim 2, in the shock absorbing structure in an idler according to claim 1, the center of each outlet of said oil injection holes is at a position shifted from the center of said each tooth gap. Therefore, in addition to the effects obtained by claim 1 the following effect can be obtained.

Even in a case where a position where the roller first abuts when the roller engages with an idler sprocket is a position shifted from the center of each tooth gap, the shock applied by pressure of oil injected from an outlet of the oil injection hole to each tooth gap when a roller of the roller chain first abuts on each tooth gap of the idler sprocket, can be absorbed.

### BRIEF DESCRIPTION OF THE DRAWINGS

FIG. 1 is a cross-sectional view of a principal portion of a shock absorbing structure in an idler of a first embodiment

FIG. 2 is a cross-sectional view taken along the line A-A in FIG. 1, and shows a state where an oil injection hole and an oil supply hole are aligned with each other.

FIG. 3 is a cross-sectional view taken along the line A-A in FIG. 1, and shows a state where an oil injection hole and an oil supply hole are shifted with respect to each other.

FIG. 4 shows a shock absorbing structure in an idler of a second embodiment and is a cross-sectional view corresponding to FIG. 2, which shows a state where an oil injection hole and an oil supply hole are aligned with each other.

FIG. 5 shows a shock absorbing structure in an idler 1 of a third embodiment and is a cross-sectional view corresponding to FIG. 2, which shows a state where an oil injection hole and an oil supply hole are aligned with each other.

### PREFERRED EMBODIMENTS FOR CARRYING OUT THE INVENTION

A preferred embodiment for carrying out the present invention is one in which the present invention is adapted for an idler in a transmission mechanism by a timing roller chain of an engine. This embodiment is described as follows.

In a shock absorbing structure in an idler comprising a supporting shaft 2 fixed to an engine block (fixed body) 9, an idler sprocket 3 of a standard tooth form rotatably supported onto the supporting shaft 2 and a timing roller chain 4 in which a roller 5 engages with the idler sprocket 3, the supporting shaft 2 is provided with one oil supply hole 2c in a substantially radial direction, the supporting shaft 2 is positioned such that the oil supply hole 2c extends toward a position where the roller 5 first abuts when the roller 5 engages with the idler sprocket 3, and is fixed to the engine block (fixed body) 9, the idler sprocket 3 is provided with a plurality of oil injection holes 3b extending in a substantially radial direction, and each terminating in an outlet opening in the bottom of one tooth gap 3a of the idler sprocket 3 such that the oil injection holes 3b register with the oil supply hole 2c. The oil supply hole 2c communicates with an oil pump (oil supply source) 11 through an oil reservoir 10.

The respective embodiments of the present invention will be described below.

### The First Embodiment

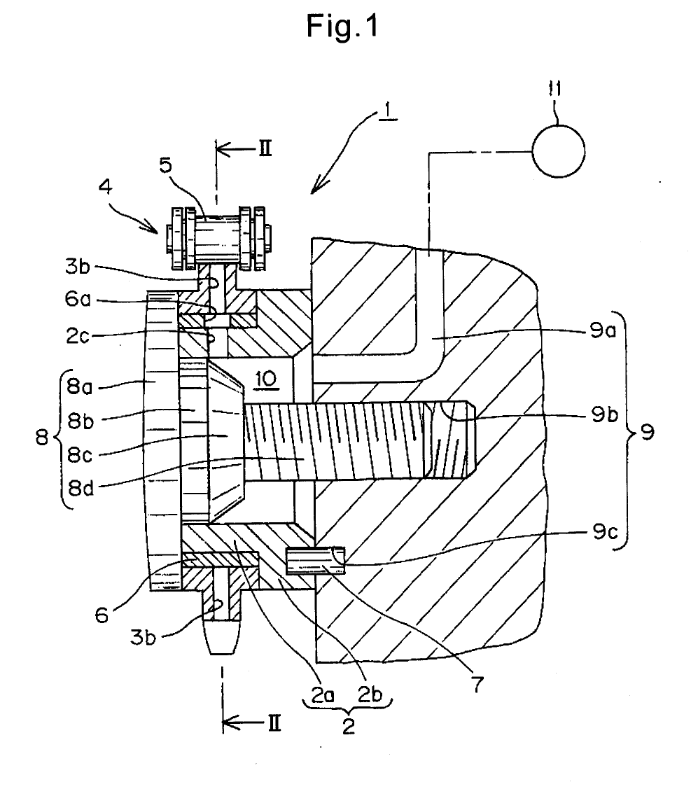

The first embodiment of the present invention is a case adapted for an idler of a transmission mechanism by a timing roller chain of an engine. The first embodiment of the present invention will be described with reference to FIGS. 1 to 3.

The shock absorbing structure in an idler 1 of the first embodiment of the present invention is formed as follows.

An idler 1 is composed of a supporting shaft 2 fixed to an engine block (fixed body) 9, an idler sprocket 3 of a standard tooth form, rotatably supported on the supporting shaft 2 and a timing roller chain 4 in which a roller 5 engages with the idler sprocket 3, as shown in FIG. 1.

The supporting shaft 2 is composed of a hollow body having a flange 2b at one end of a cylindrical portion 2a, and approximately halfway along its length the cylindrical portion 2a is provided with one oil supply hole 2c extending in a substantially radial direction.

The cylindrical potion of the shaft 2 has an outer circumferential surface which mounts a slide bearing 6 having one oil communicating hole 6a. The slide bearing 6 is adhered to the shaft so that the one oil supply hole 2c and the oil communicating hole 6a are aligned with each other.

The supporting shaft 2 is fixed to an engine block (fixed body) 9. by a positioning pin 7 and a mounting bolt 8 to be described later so that the oil supply hole 2c is directed toward a position where a roller 5 first abuts when the roller 5 engages with a tooth gap 3a of an idler sprocket 3 as the chain 4 travels from a free run to a path around the sprocket.

The idler sprocket 3 is rotatably supported on the cylindrical portion 2a of the supporting shaft 2 through the slide bearing 6.

Around the idler sprocket 3 are radially provided a series of oil injection holes 3b in a substantially radial direction whose outlets are opened in the respective tooth gaps 3a.

And when the idler sprocket 3 is incorporated into the cylindrical portion 2a of the supporting shaft 2 through the slide bearing 6 so as to rotatably fit-supported, a plurality of oil injection holes 3b in a substantially radial direction face an oil supply hole 2c in the radial direction.

The mounting bolt 8 has a flange portion 8a at its proximal portion, and continuously to this flange portion 8a is formed a fixing portion 8b, which matches the inner circumferential surface of the cylindrical portion 2a of the supporting shaft 2.

Further, continuously to the fitting portion 8b is formed a screw portion 8d of a small diameter through a tapered portion 8c. This screw portion 8d is screwed into a screw hole 9b of a cylinder block (fixed body) 9 to mount the supporting shaft 2 onto the cylinder block (fixed body) 9.

In this case the fitting portion 8b of the mounting bolt 8 is tightly fitted onto an inner circumferential surface of the cylindrical portion 2a of the supporting shaft 2, so that the fitting portion 8b and the inner circumferential surface of the cylindrical portion 2a of the supporting shaft 2 are in an oiltightness state.

And when the supporting shaft 2 is mounted onto the cylinder block (fixed body) 9 by the mounting bolt 8, the idler sprocket 3 is arranged between the flange portion 8a of the mounting bolt 8 and the flange portion 2b of the supporting shaft 2 and is prevented from disconnection. And at the same time the idler sprocket 3 is positioned so that a plurality of oil injection holes 3b in a substantially radial direction face the oil supply hole 2c in a radial direction.

Further the back side of the flange portion 2b of the supporting shaft 2 is provided with a positioning pin 7, and this positioning pin 7 is fitted into a pin hole 9c formed in the cylinder block (fixed body) 9 whereby the supporting shaft 2 is positioned to the cylinder block (fixed body) 9 so that the oil supply hole 2c faces a position where a roller 5 first abuts when the roller 5 engages with the idler sprocket 3.

On an inner circumferential surface side of the supporting shaft 2 is formed an oil reservoir 10 by the inner circumferential surface of the supporting shaft 2, the mounting bolt 8 and a side surface of the cylinder block (fixed body) 9. And the inlets of the oil supply holes 2c are opened at this oil reservoir 10.

In this cylinder block (fixed body) 9 is formed an oil passage 9a, which communicates with an oil pump (oil supply source) 11. And the outlet of this oil passage 9a is opened at the oil reservoir 10.

Therefore, the oil supply hole 2c communicates with the oil pump (oil supply source) 11 through the oil reservoir 10.

Next, an operation of the shock absorbing structure in the idler 1 of the first embodiment of the present invention will be described.

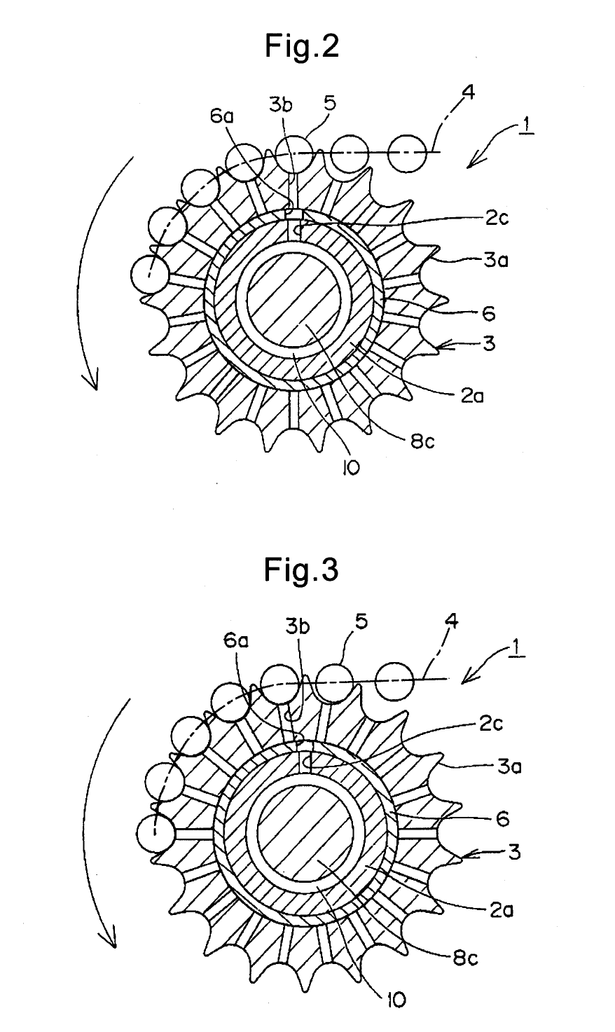

As shown in FIGS. 2 and 3, when a timing roller chain 4 is moved in the arrow direction (counterclockwise) while the timing roller chain 4 engages with the idler sprocket 3, the idler sprocket 3 is rotated in the arrow direction (counterclockwise) on an outer circumference of the slide bearing 6 adhered to an outer circumference of the cylindrical portion 2a of the supporting shaft 2.

In this case as shown in FIG. 2, when the outlet of the oil supply hole 2c and the oil communicating hole 6a are aligned with an inlet of the oil injection holes 3b, oil supplied from the oil pump (oil supply source) 11 to the oil reservoir 10 through the oil passage 9a is sent to oil injection holes 3b, and the oil is injected from an outlet of the oil injection holes 3b to a tooth gap 3a of the idler sprocket 3.

Since the oil supply hole 2c is positioned so as to directed toward a position where a roller 5 first abuts when the roller 5 engages with the idler sprocket 3, the shock of the roller on the tooth gap 3a when the roller 5 first abuts on a tooth gap 3a is absorbed by the oil injected into the gap from the outlet of the oil injection hole 3b.

Further, as the idler sprocket 3 is rotated by the travel of the chain, the oil supply hole 2c and the oil communicating hole 6a are shifted in a circumferential direction with respect to the inlet of the oil injection hole 3b as shown in FIG. 3, the flow of oil is shut out between the oil supply hole 2c and the oil injection hole 3b. Thus the injection of oil from the oil injection hole 3b to the tooth gap 3a of the idler sprocket 3 is stopped until the travel of the chain rotates the sprocket to register the oil injection hole 3b of the next tooth gap in the series with the holes 2c and 6a.

When the idler sprocket 3 is subsequently rotated and the outlet of the oil supply hole 2c and the oil communicating hole 6a are again aligned with an inlet of the oil injection hole 3b as shown in FIG. 2, the shock applied by pressure of oil, which injects from the outlet of the oil injection hole 3b when the subsequent roller 5 first abuts on a tooth gap 3a of the idler sprocket 3, is absorbed.

Every time when the outlet of the oil supply hole 2c and an inlet of the oil injection hole 3b are aligned with each other, oil is injected into a tooth gap 3a of the idler sprocket 3, and the shock resulting from the roller 5 is absorbed by pressure of oil, which is injected from the outlet of the oil injection hole 3b when the subsequent roller 5 of the series first abuts on a tooth gap 3a of the idler sprocket 3.

As described above, the cylindrical portion 2a of the supporting shaft 2 and the idler sprocket 3 function as an on-off valve, which interrupts the connection between the oil supply hole 2c and the oil injection hole 3b, by rotation of the idler sprocket 3.

Advantageous effects of the shock absorbing structure in the idler 1 of the first embodiment of the present invention will be described.

Since the idler sprocket 3 is provided with a plurality of oil injection holes 3b in a substantially radial direction, whose outlets are open in the respective tooth gaps 3a, the shock can be absorbed by pressure of oil, which is injected from the outlet of the oil injection hole 3b in to each tooth gap 3a when the roller 5 of the timing roller chain 4 first abuts on each tooth gap 3a of the idler sprocket 3.

Since oil is injected from an outlet of the oil injection holes 3b to a tooth gap 3a of the idler sprocket 3 only when the outlet of the oil supply hole 3b is aligned with an inlet of the oil injection holes 3b, the consumption of oil can be decreased.

Since the oil injected into the tooth gap 3a of the idler sprocket 3 has a function of lubricating oil, wear of parts can be prevented.

Further, the oil injected into the tooth gap 3a of the idler sprocket 3 has a cooling effect, which cools the idler sprocket 3 and the timing roller chain 4.

Since in a related art, an elastic shock absorber liable to generate wear or worn-out condition is used, continuation of the shock absorbing effect for a long period of time is impossible. However, according to the present example since the shock applied by pressure of injected oil when the roller 5 first abuts, is absorbed, its function can be maintained for a long period of time.

It is noted that the above-described the first embodiment describes an example in which one-oil communicating hole 6a-formed slide bearing 6 is adhered to an outer circumferential surface of the cylindrical portion 2a of the supporting shaft 2, and one oil supply hole 2c and one oil communicating hole 6a are aligned with each other.

However, as a modified embodiment, even a modification to adhere a slide bearing (not shown) to an inner circumferential surface of the idler sprocket 3 can be adopted.

In the case of this modified embodiment, a slide bearing (not shown) provided with oil communicating holes of the same number as the oil injection holes 3b of the idler sprocket 3 is used and the slide bearing (not shown) is adhered to the inner circumferential surface of the idler sprocket 3 so that the respective oil injection holes 3b and the respective oil communicating holes are aligned with each other.

### The Second Embodiment

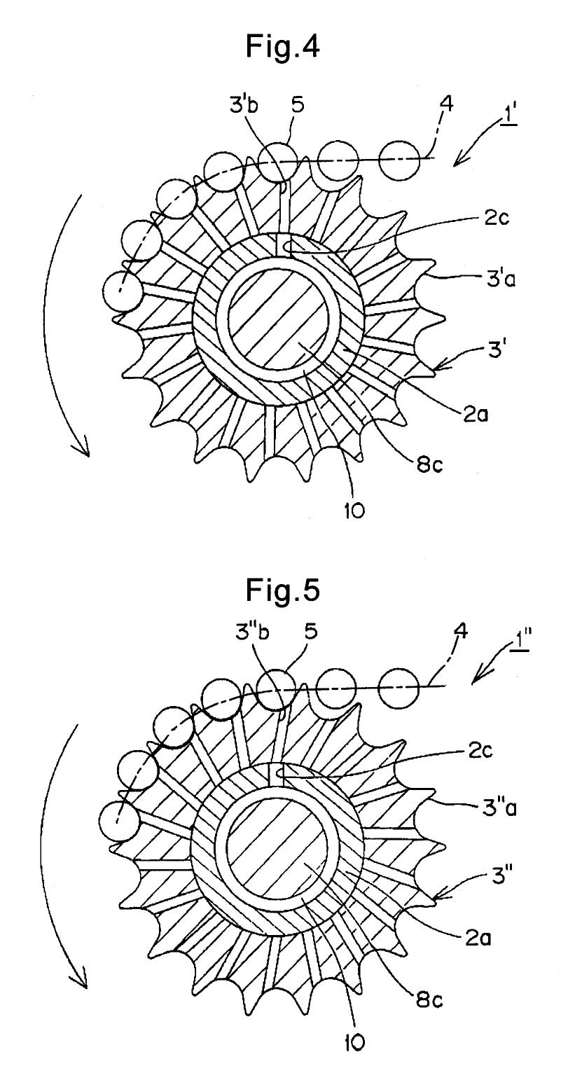

The second embodiment of the present invention will be described with reference to FIG. 4. FIG. 4 shows a shock absorbing structure in an idler 1′ of the second embodiment and is a cross-sectional view corresponding to FIG. 2, which shows a state where an oil injection hole and an oil supply hole are aligned with each other.

Since the shock absorbing structure in the idler 1′ of the second embodiment has the following two differences from the shock absorbing structure in the idler 1 of the first embodiment, and other components of the second embodiment are the same as those of the first embodiment, and are given the same reference characters. The differences only are described below and the explanation of other components is omitted.

The first difference is that the slide bearing 6 used in the first embodiment is not used as shown in FIG. 4.

Therefore, in the second embodiment, an idler sprocket 3′ of a standard tooth form is directly supported on a cylindrical portion 2a of a supporting shaft 2 with a rotating fit, not through a slide bearing 6.

The second difference is that the centers of the respective outlets of oil injection holes 3′b are at positions shifted from the centers of the respective tooth gaps 3′a as shown in FIG. 4.

In order to form the centers of the respective outlets of the oil injection holes 3∝b at positions shifted from the centers of the respective tooth gaps 3′a the respective oil injection holes 3′b are slightly shifted opposite to the direction of rotation of the sprocket and parallel to a true radial direction.

By this configuration even in a case where a position where the roller 5 first abuts when the roller 5 engages with an idler sprocket 3′ is a position shifted from the center of each tooth gap 3′a, the shock applied by pressure of oil injected from an outlet of the oil injection hole 3′b to each tooth gap 3′a when the roller 5 of the timing roller chain 4 first abuts on each tooth gap 3′a of the idler sprocket 3′, can be absorbed.

### The Third Embodiment

The third embodiment of the present invention will be described with reference to FIG. 5. FIG. 5 shows a shock absorbing structure in an idler 1″ of the third embodiment and is a cross-sectional view corresponding to FIG. 2, which shows a state where an oil injection hole and an oil supply hole are aligned with each other.

Since the shock absorbing structure in the idler 1″ of the third embodiment has the following two differences from the shock absorbing structure in the idler 1 of the first embodiment, and other components of the third embodiment are the same as those of the first embodiment, the differences only are described below and the explanation of other components is omitted.

The first difference is that the slide bearing 6 used in the first embodiment is not used as shown in FIG. 5.

Therefore, in the third embodiment, an idler sprocket 3″ of a standard tooth form is supported for rotation by a rotating fit on a cylindrical portion 2a of a supporting shaft 2 not through a slide bearing 6.

The second difference is that the centers of the respective outlets of oil injection holes 3″b are at positions shifted from the centers of the respective tooth gaps 3″a as shown in FIG. 5.

In order to form the centers of the respective outlets of the oil injection holes 3″b at positions shifted from the centers of the respective tooth gaps 3″a the respective oil injection holes 3″b are canted from a true radial direction oppositely to the direction of rotation of the sprocket. The canting of the holes 3″b in this direction assists the migration of the oil outwardly into the gaps 3″a as the chain causes the sprocket to rotate.

By this configuration even in a case where a position where the roller 5 first abuts at the time when the roller 5 engages with an idler sprocket 3″ is a position shifted from the center of each tooth gap 3″a, the shock applied when the roller 5 of the timing roller chain 4 first abuts on each tooth gap 3″a of the idler sprocket 3″ can be absorbed by pressure of oil injected from an outlet of the oil injection hole 3″b to each tooth gap 3″a.

It is noted that although the above-described examples 1, 2 and 3 are each cases where the present invention was adapted to an idler of a transmission mechanism by a timing roller chain of an engine, the present invention can be also adapted to idlers in other fields. The term idler sprocket embraces other sprockets which may have function other than to drive the roller chain in its travel.

Further, although examples 1, 2 and 3 respectively use standard tooth form sprockets 3, 3′ and 3″, an oil injection holes-provided sprocket other than the standard tooth form sprocket can be used in an idler sprocket as a modified example in the present invention.

The sprockets other than standard tooth form sprocket, which can be used as modified examples, are the following two sprockets.

The one is a sprocket described in Japanese Laid-Open Patent Publication No. 2007-107617 (a sprocket for a standard chain), and in the tooth form of this sprocket a root diameter (a diameter of a circle of a tooth gap) is larger than a root diameter of the standard tooth form.

Another one is a sprocket described in the specification of Japanese Patent Application No. 2006-189491 (a chain transmission device), and this sprocket has at least two kinds of chordal pitches having different sizes. These chordal pitches are irregularly arranged along the circumferential direction of a pitch circle.

In any sprockets described in the above-mentioned Japanese Laid-Open Patent Publication No. 2007-107617(a sprocket for a standard chain) and the specification of Japanese Patent Application No. 2006-189491 (a chain transmission device), the shock noises generated when a roller of the roller chain first abuts are decreased by improvement of the tooth forms of the sprockets.

Thus when the above-mentioned oil injection holes-provided sprocket having improved a tooth form is used as a modified sprocket example, synergetic effects of a decrease in shock noises of the roller by improvement of a tooth form and absorption of the roller shock due to oil pressure can be obtained.

1. A shock absorbing structure in an idler comprising a fixed body having a supporting shaft, an idler sprocket rotatably supported onto said supporting shaft, and a roller chain having a series of rollers adapted to travel from a free run into a path around said sprocket, said sprocket having a central bore and a series of peripheral teeth separated by a series of tooth gaps in which said series of rollers engages, the travel of said chain causing said sprocket to rotate on said supporting shaft, characterized in that
said supporting shaft is provided with a central reservoir and an outer circumference about which said sprocket rotates, and one oil supply hole extending from said reservoir in a substantially radial direction and terminating in said outer circumference, said reservoir adapted to be connected to an oil supply source,
said supporting shaft is positioned such that said oil supply hole extends toward a position where said roller first engages with said idler sprocket in its path around the sprocket, and terminates in a discharge opening in the outer circumference of said shaft, and.
said idler sprocket is provided with a plurality of oil injection holes, each extending from said bore in a substantially radial direction and terminating in an outlet in one of said tooth gaps of said idler sprocket, said oil injection holes in aid bore registering with the discharge opening of said oil supply hole, whereby oil from the oil supply source may flow through said reservoir, said oil supply hole, and said oil injection hole into the tooth gap first engaged by the roller chain in its travel from the free run into its path around the sprocket.

2. A shock absorbing structure in an idler according to claim 1, characterized in that the outlet of each of said oil injection holes is positioned at the center of said each tooth gap bottom.

3. A shock absorbing structure in an idler according to claim 1, characterized in that the outlet of each of said oil injection holes is positioned at the center of said each tooth gap bottom, and said injection holes extend in a true radial direction.

4. A shock absorbing structure in an idler according to claim 1, characterized in that the outlet of each of said oil injection holes is offset from at the center of said each tooth gap bottom.

5. A shock absorbing structure in an idler according to claim 4, wherein each of said oil injection holes is canted from a true radial direction oppositely to the direction of rotation of said sprocket.

6. A shock absorbing structure in an idler according to claim 1, including a slide bearing adhered to the outer circumference of said shaft and rotatably mounting said bore of the sprocket, said bearing having hole registering with said discharge opening and operable to register with the oil injection hole which terminates in the tooth gap which receives the roller which first engages the sprocket in its travel from the free run to a path around the sprocket.
